(19) United States
(12) Patent Application Publication
(10) Pub. No.: US 2025/0323513 A1
(43) Pub. Date: Oct. 16, 2025

(54) SEMICONDUCTOR DEVICE, METHOD OF BALANCING BATTERY MODULE, AND BATTERY MODULE SYSTEM

(71) Applicant: Renesas Electronics Corporation, Tokyo (JP)

(72) Inventors: Yusuke SUGAWARA, Tokyo (JP); Masaki HOGARI, Tokyo (JP); Gen NAGASHIMA, Tokyo (JP)

(21) Appl. No.: 19/174,374

(22) Filed: Apr. 9, 2025

(30) Foreign Application Priority Data
Apr. 10, 2024 (JP) 2024-063504

(51) Int. Cl. H02J 7/00

(52) U.S. Cl. CPC H02J 7/0016; H02J 7/00714

(57) ABSTRACT

A semiconductor device is provided, the semiconductor device comprises a first battery module and a second battery module connected in series, the first battery module comprising a first controlling portion controlling a first cell group where a plurality of battery cells are connected in series; and a controller communicating with a device driven when receiving a power supply from the first and second battery modules, the second battery module comprising a second controlling portion controlling a second cell group where a plurality of battery cells are connected in series; and a first measuring circuit measuring a difference in a consumed electrical amount between the first battery module and the second battery module, and discharge starts from the plurality of battery cells included in the second cell group, based on the difference in the consumed electrical amount measured by the first measuring circuit.

### CROSS-REFERENCE TO RELATED APPLICATION

The disclosure of Japanese Patent Application No. 2024-063504 filed on Apr. 10, 2024, including the specification, drawings and abstract is incorporated herein by reference in its entirety.

### BACKGROUND

The present disclosure relates to a semiconductor device, a method of balancing a battery module, and a battery module system.

As a related art, it is known that capacity unbalance (cell unbalance) among the cells occurs depending on variation in manufacturing of cells of a battery or individual difference in degradation due to long-term use. Charge or discharge in such a state possibly causes overcharge or overdischarge on some cells. Also, in the case of the overcharge or overdischarge on some cells, the charge/discharge may be stopped by a protection function of this cell. In this case, the essential performance may be not sufficiently exerted, in spite of a state in which other cells are available.

There is disclosed a technique listed below.
[Patent Document 1] Japanese Unexamined Patent Application Publication No. 2019-058013

In an assembled battery made of a plurality of cells, a technique of equalizing voltages of the respective cells (cell balance) or the like is known in order to prevent the occurrence of the overcharge/overdischarge due to variation in a remaining capacity among the cells (see, for example, the Patent Document 1).

### SUMMARY

If a plurality of battery modules (battery packs, assembled batteries) each including a plurality of cells connected in series are connected in series for use, capacity unbalance (module unbalance) occurs due to a difference in a consumed electric current among the battery modules. The related art has a room to be improved regarding, for example, a method of balancing a cell in the case in which the plurality of battery modules (battery packs, assembled batteries) each including the plurality of cells connected in series are connected in series for use. Other objects and novel characteristics will be apparent from the description of the present specification and the accompanying drawings.

According to one embodiment of the present disclosure, a semiconductor device comprises a first battery module and a second battery module connected in series is provided, the first battery module comprising a first controlling portion controlling a first cell group where a plurality of battery cells are connected in series, and a controller communicating with a device driven when receiving a power supply from the first and second battery modules, the second battery module comprising a second controlling portion controlling a second cell group where a plurality of battery cells are connected in series, and a first measuring circuit measuring a difference in a consumed electrical amount between the first battery module and the second battery module, and discharge starts from the plurality of battery cells in the second cell group, based on the difference in the consumed electrical amount measured by the first measuring circuit.

According to one embodiment of the present disclosure, a method of balancing a battery module is provided, a step of providing a first battery module and a second battery module are provided, the first battery module comprising a first cell group where a plurality of battery cells are connected in series; and a controller communicating with a device driven when receiving a power supply from the first and second battery modules, the second battery module comprising a second cell group where a plurality of battery cells are connected in series, a step of measuring a difference in a consumed electrical amount between the first battery module and the second battery module; and a step of starting discharge from the plurality of battery cells included in the second cell group, based on the measured difference in the consumed electrical amount.

According to one embodiment of the present disclosure, a battery module system including a first battery module and a second battery module connected in series is provided, the first battery module comprising a first cell group where a plurality of battery cells are connected in series; a first controlling portion controlling the first cell group; and a controller communicating with a device driven when receiving a power supply from the first and second battery modules, the second battery module comprising a second cell group where a plurality of battery cells are connected in series; a second controlling portion controlling the second cell group; and a first measuring circuit measuring a difference in a consumed electrical amount between the first battery module and the second battery module, and discharge starts from the plurality of battery cells included in the second cell group, based on the difference in the consumed electrical amount measured by the first measuring circuit.

According to an aspect, in a case in which a plurality of battery modules are connected in series for use, cell balance can be more suitably executed.

### BRIEF DESCRIPTIONS OF THE DRAWINGS

FIG. 1 is a diagram showing an example of a configuration of an apparatus according to an embodiment.

FIG. 2 is a diagram showing an example of a configuration of a battery pack (bottom module) according to the embodiment.

FIG. 3 is a diagram showing an example of a configuration of a battery pack (middle module) according to the embodiment.

FIG. 4 is a diagram showing an example of a configuration of a battery pack (top module) according to the embodiment.

FIG. 5 is a diagram showing an example of a current flow in each battery pack according to the embodiment.

FIG. 6 is a flowchart showing an example of a process of balancing the battery packs according to the embodiment.

FIG. 7 is a diagram showing an example of a configuration of a controlling portion according to the embodiment.

### DETAILED DESCRIPTION

The principle of the present disclosure will be explained with reference to some exemplary embodiments. These embodiments are described for only exemplification, and it would be understood that these embodiments support the understanding and the demonstration of the present disclosure for those skilled in the art without teaching the limitation of the scope of the present disclosure. The disclosure explained in the present specification may be demonstrated by various methods other than the following explained methods.

In the following explanation and scope of the claims, all technical and scientific terms used in the present specification has the same meanings as those generally understood by those skilled in the art of the technical field to which the present disclosure pertains unless otherwise defined to other meanings.

The embodiments of the present disclosure will be explained below with reference to drawings.

### <Configuration>

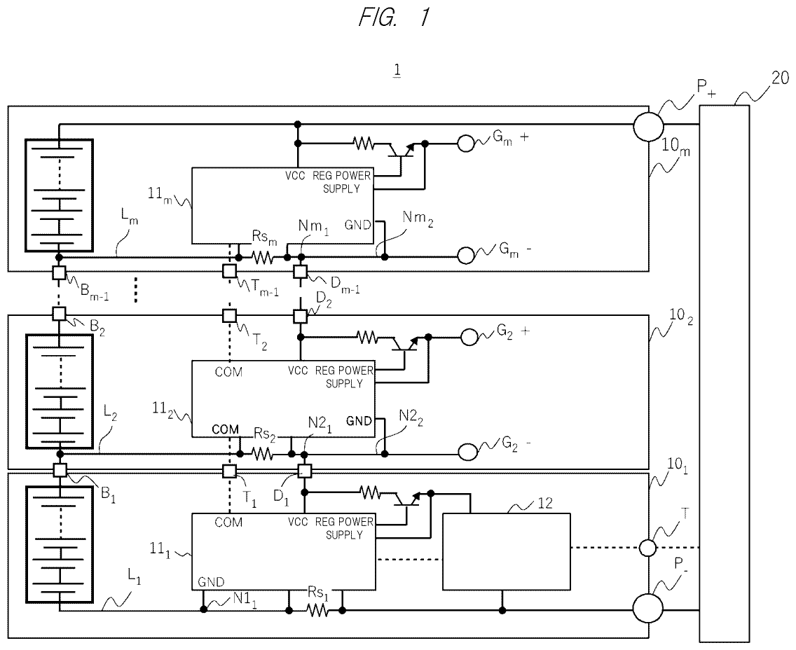

With reference to FIG. 1, a configuration of an apparatus 1 according to the embodiment will be explained. FIG. 1 is a diagram showing an example of the configuration of the apparatus 1 according to the embodiment. The apparatus 1 may be, for example, a personal computer, a server, a household apparatus, a factory apparatus, a vehicle or the like. Examples of the vehicle of the present disclose may include, for example, an Electric Vehicle (EV), a Hybrid Electric Vehicle (HEV), an electric motorcycle, a motor-assisted bicycle, a motor kickboard (electric kick scooter) and the like.

In the example of FIG. 1, the apparatus 1 includes battery packs 10₁ to 10ₘ (“m” is an integer number that is equal to or larger than 2), and a main body 20. The main body 20 is a main body portion of the apparatus 1, and is a device driven when receiving a power supply from the battery packs 10₁ to 10ₘ. Note that the battery packs 10₁ to 10ₘ may be housed in a casing of the main body 20. Unless it is necessary to individually discriminate the battery packs 10₁ to 10ₘ below, the battery packs may be also simply referred to as “battery pack 10”. Note that the number of the battery packs in the present disclosure may be equal to or larger than 2. If the number of the battery packs is 2 (m=2), note that the apparatus includes only the battery pack 10₁ (bottom module) and the battery pack 10ₘ (top module), and does not include a middle module described later. Note that the battery packs 10₁ to 10ₘ can be also referred to as “battery module system”. Also, a portion excluding each battery cell of the battery packs 10₁ to 10ₘ can be also referred to as “battery-module balance control system”.

The battery packs 10₁ to 10ₘ are electrically connected in series in an order of the battery packs “10₁, 10₂, . . . 10ₘ”. Note that the battery packs 10₁ to 10ₘ may be needed to be only electrically connected in series in this order, and an order for physical arrangement is optional. Therefore, for example, the battery packs 10₁ to 10ₘ may be physically arranged in the order of the battery packs “10₁, 10₂, . . . 10ₘ” vertically from a lower side, or may be physically arranged in another order.

A negative electrode of the battery pack 10₁ (bottom module) is electrically connected to the main body 20 at a connection point “P−”, and a positive electrode of the battery pack 10ₘ (top module) is electrically connected to the main body 20 at a connection point “P+”.

The battery pack 10₁ that is the bottom module is electrically connected to the battery pack 10₂ at a connection point “D₁”. And, a battery pack 10ₖ (“k” is an integer number that is any number of 2 to “m−1”) that is the middle module is electrically connected to the battery pack 10ₖ₋₁ at a connection point “Dₖ₋₁ (such as D₁ in the case of the battery pack 10₂)”, and is electrically connected to the battery pack 10ₖ₊₁ at a connection point “Dₖ (such as D₂ in the case of the battery pack 10₂)”. Also, the battery pack 10ₘ that is the top module is electrically connected to the battery pack 10ₘ₋₁ at a connection point “Dₘ₋₁”.

A positive electrode of the battery pack 10₁ that is the bottom module is electrically connected to a negative electrode of the battery pack 10₂ at a connection point “B₁”. A positive electrode of the battery pack 10ₖ that is the middle module is electrically connected to a negative electrode of the battery pack 10ₖ₊₁ at a connection point “Bk (such as B₂ in the case of the battery pack 10₂)”. A negative electrode of the battery pack 10ₖ is electrically connected to a positive electrode of the battery pack 10ₖ₋₁ at a connection point “Bₖ₋₁ (such as B₁ in the case of the battery pack 10₂)”. A negative electrode of the battery pack 10ₘ that is the top module is electrically connected to a positive electrode of the battery pack 10ₘ₋₁ at a connection point “Bₘ₋₁”.

The battery pack 10₁ is electrically connected to the main body 20 at a communication connection point “T” for notification of a battery state of each of the battery packs 10₁ to 10ₘ or the like. The battery pack 10₁ that is the bottom module is communicably connected to the battery pack 10₂ at a communication connection point “T” for reception of the notification of the battery state or the like. The battery pack 10ₖ that is the middle module is communicably connected to the battery pack 10ₖ₊₁ at a communication connection point “Tₖ (such as T₂ in the case of the battery pack 10₂)” for reception of the notification of the battery state of each of the battery packs 10₁ to 10ₘ or the like. The battery pack 10ₖ is communicably connected to the battery pack 10ₖ₋₁ at a communication connection point “Tₖ₋₁ (such as T₁ in the case of the battery pack 10₂)” for notification of a battery state of each of the battery packs 10ₖ to 10ₘ or the like. The battery pack 10ₘ that is the top module is communicably connected to the battery pack 10ₘ₋₁ at a communication connection point “Tₘ₋₁” for notification of a battery state of the battery pack 10ₘ or the like.

### <<Configuration of Battery Pack 10₁ (Bottom Module)>>

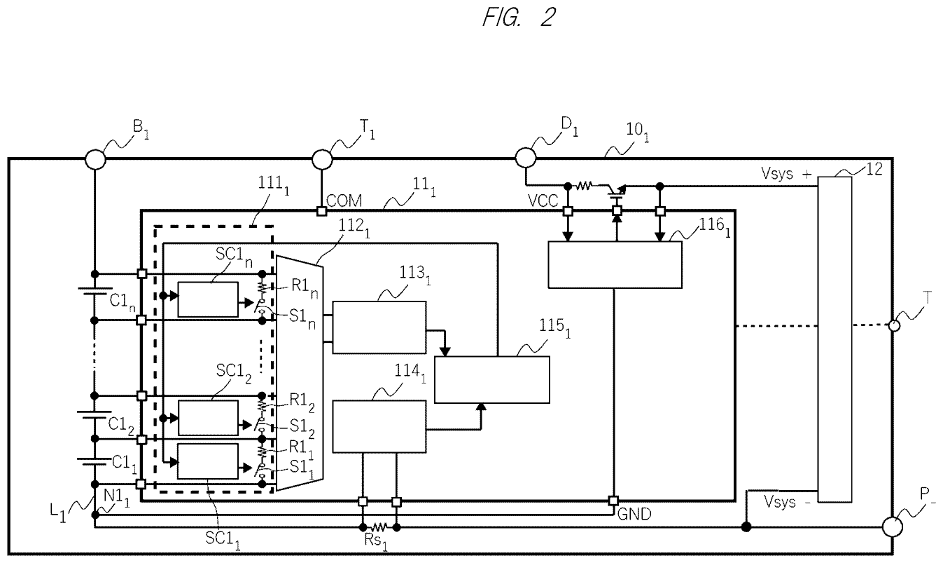

Next, with reference to FIG. 2, a configuration of the battery pack 10₁ according to the embodiment will be explained. FIG. 2 is a diagram showing an example of the configuration of the battery pack 10₁ (bottom module) according to the embodiment. In the example of FIG. 2, the battery pack 10₁ includes battery cells C1₁ to C1ₙ (“n” is an integer number that is equal to or larger than 2), a battery manager IC11₁, and a controller (battery management system (BMS) control device) 12. The battery cells C1₁ to C1ₙ are electrically connected in series. The battery cells C1₁ to C₁n that are electrically connected in series are also referred to as first cell group below if needed. The controller 12 notifies the main body 20 of information about the battery state of each battery cell of each battery pack 10 or the like.

In the example of FIG. 2, a positive electrode of the first cell group is connected to the connection point B₁. The connection point D₁ is connected to the controller 12 through a series regulator 116₁. The series regulator 116₁ is connected to a negative electrode of the first cell group without being through a sensing resistor R_{S1}. The negative electrode of the first cell group is connected to the connection point P− for the main body 20 and the controller 12 through the sensing resistor R_{S1} by using a line L₁ connected to the negative electrode of the first cell group.

The battery manager IC11₁ and the controller 12 receive a power supply through a line L₂ connected to the battery pack 10₂ at a connection point N2₁, and are grounded at the line L₁ connected at a connection point N1₁.

The battery manager IC11₁ includes a cell balance 111₁, a selecting circuit 112₁, a voltage measuring circuit 113₁, a current measuring circuit 114₁, a controlling portion 115₁, and a series regulator 116₁. In the cell balance 111₁, a combination of resistors R1₁ to R1ₙ, switches S1₁ to S1ₙ, switch controlling circuits SC1₁ to SC1ₙ for controlling each switch are provided for each of the battery cells C1₁ to C1ₙ.

The selecting circuit 112₁ is a circuit for electrically connecting only one battery cell of the battery cells C1₁ to C1ₙ, the battery cell being assigned by the controlling portion 115₁, to the voltage measuring circuit 113₁.

The voltage measuring circuit 113₁ measures each voltage of the battery cells C1₁ to C1ₙ connected in series. The voltage measuring circuit 113₁ is a circuit for measuring a voltage of a battery cell of the battery cells C1₁ to C1ₙ, the battery cell being selected by the selecting circuit 112₁.

The current measuring circuit 114₁ measures a current flowing in the battery cells C1₁ to C1ₙ connected in series. The current measuring circuit 114₁ measures the current flowing in the battery cells C1₁ to C1ₙ, based on a magnitude of voltage drop of the sensing resistor R_{S1} provided on an electric circuit connected to the battery cells C1₁ to C1ₙ. The controlling portion 115₁ adjusts a power of at least one battery cell of the battery cells C1₁ to C1ₙ, based on a result measured by the voltage measuring circuit 113₁ and a result measured by the current measuring circuit 114₁. The series regulator 116₁ generates a power supply supplied to, for example, the battery manager IC11₁.

### <<Configuration of Battery Pack 10ₖ (Middle Module)>>

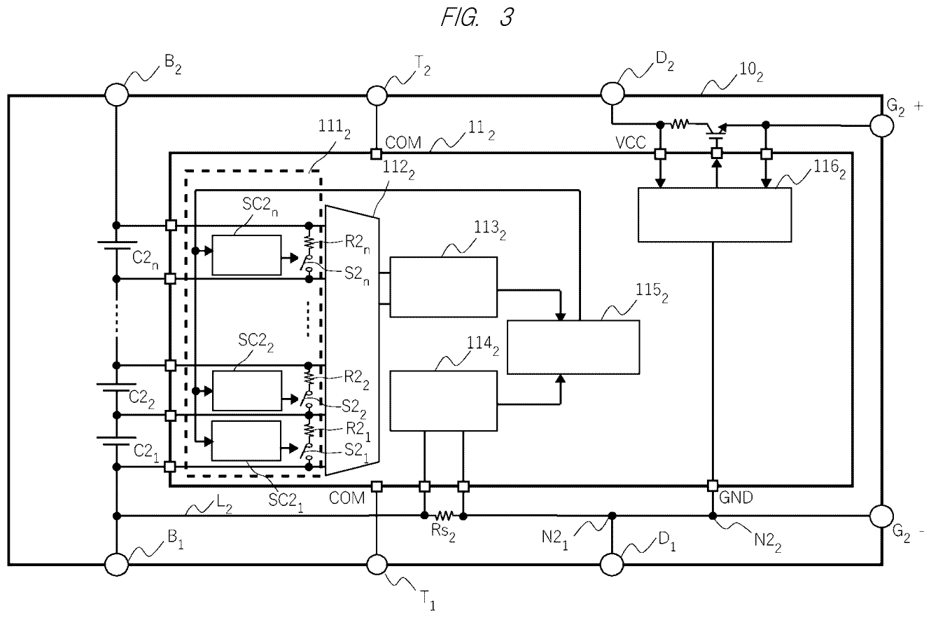

Next, with reference to FIG. 3, a configuration of the battery pack 10ₖ according to the embodiment will be explained. FIG. 3 is a diagram showing an example of the configuration of the battery pack 10ₖ (middle module) according to the embodiment. In the example of FIG. 3, an example of the battery pack 10₂ is illustrated as the battery pack 10ₖ. If the apparatus 1 includes a plurality of middle modules, each example of the battery packs 10₃ to the 10ₘ₋₁ may be the same as the example of the battery pack 10₂.

The battery pack 10₂ includes the battery cells C2₁ to C2ₙ and a battery manager IC11₂. Note that the number “n” of the battery cells of the battery pack 10₂ may be different from the number “n” of the battery cells of other battery packs 10. The battery cells C2₁ to C2ₙ are electrically connected in series. The battery cells C2₁ to C2ₙ that are connected in series are also simply referred to as “second cell group” below if needed.

In the example of FIG. 3, a negative electrode of the second cell group is electrically connected to a positive electrode of the first cell group through a connection point “B₁”. Also, a positive electrode of the second cell group is connected to a connection point “B₂”. A connection point “D₂” is connected to an external-apparatus connection point “G₂+” and a series regulator 116₂. The series regulator 116₂ is connected to each of the connection point “D₁” and an external-apparatus connection point “G₂−” without being through a sensing resistor R_{S2}, and is connected to the negative electrode of the second cell group through the sensing resistor R_{S2} by using the line L₂.

The battery manager IC11₂ receives a power supply through a line L₃ (that is Lₘ in the case of “m=3”) connected to the battery pack 10₃ (that is 10ₘ in the case of “m=3”) at a connection point N3₁ (that is N3ₘ in the case of “m=3”), and is grounded at the line L₂ connected at a connection point N2₂. The connection point N2₁ is arranged on the line L₂ between the sensing resistor R_{S2} and a ground connection point N2₂ of the battery manager IC11₂. The sensing resistor R_{S2} is arranged between the positive electrode of the first cell group and the connection point N2₁.

The battery manager IC11₂ includes a cell balance 111₂, a selecting circuit 112₂, a voltage measuring circuit 113₂, current measuring circuit 114₂, a controlling portion 115₂, and a series regulator 116₂. In the cell balance 111₂, a combination of resistors R2₁ to R2ₙ, switches S2₁ to S2ₙ, switch controlling circuits SC2₁ to SC2ₙ for controlling each switch are provided for each of the battery cells C2₁ to C2ₙ. The battery manager IC11₂ may be the same as the battery manager IC11₁. Therefore, the battery manager IC11₂ may be explained while rephrasing the described index “1” of the symbol in each battery pack 10 in the explanation for the battery manager IC11₁ to an index “2” or the like.

### <<Configuration of Battery Pack 10ₘ (Top Module)>>

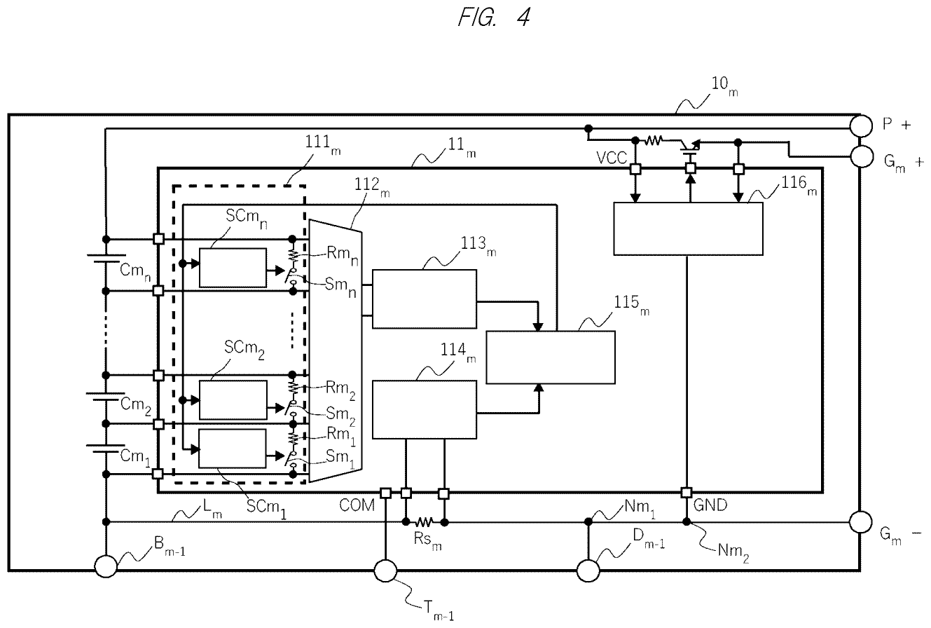

Next, with reference to FIG. 4, a configuration of the battery pack 10ₘ according to the embodiment will be explained. FIG. 4 is a diagram showing an example of the configuration of the battery pack 10ₘ (top module) according to the embodiment.

The battery pack 10ₘ includes the battery cells Cm₁ to Cmₙ and a battery manager IC11ₘ. Note that the number “n” of the battery cells of the battery pack 10ₘ may be different from the number “n” of the battery cells of other battery packs 10. The battery cells Cm₁ to Cmₙ are electrically connected in series. The battery cells Cm₁ to Cmₙ that are electrically connected in series are also simply referred to as “m-th cell group” below if needed.

In the example of FIG. 4, a negative electrode of the m-th cell group is electrically connected to a positive electrode of the cell group of the battery pack 10ₘ₋₁ through a connection point “Bₘ₋₁”. Also, a positive electrode of the m-th cell group is connected to a connection point “P+” for the main body 20, an external-apparatus connection point “Gₘ+” and a series regulator 116ₘ. The series regulator 116ₘ is connected to each of the connection point “Dₘ₋₁” and an external-apparatus connection point “Gₘ−” without being through a sensing resistor R_{Sm}, and is connected to the negative electrode of the m-th cell group through the sensing resistor R_{Sm} by using a line Lₘ. Note that the line Lₘ is connected to the negative electrode of the m-th cell group, and is electrically connected to a positive electrode of the cell group of the battery pack 10ₘ₋₁ through the connection point “Bₘ₋₁”.

The battery manager IC11ₘ receives a power supply from the positive electrode of the m-th cell group, and is grounded at the line Lₘ connected at a connection point Nm₂. The connection point Nm₁ is arranged on the line Lₘ between the sensing resistor R_{Sm} and a ground connection point Nm₂ of the battery manager IC11₂. The sensing resistor R_{Sm} is arranged between the positive electrode of the m−1-th cell group and the connection point Nm₁. The battery manager IC11ₘ includes a cell balance 111ₘ, a selecting circuit 112ₘ, a voltage measuring circuit 113ₘ, a current measuring circuit 114ₘ, a controlling portion 115ₘ, and a series regulator 116ₘ. In the cell balance 111ₘ, a combination of resistors Rm₁ to Rmₙ, switches Sm₁ to Smₙ, switch controlling circuits SCm₁ to SCmₙ for controlling each switch are provided for each of the battery cells Cm₁ to Cmₙ. The battery manager IC11ₘ may be the same as the battery manager IC11₁. Therefore, the battery manager IC11ₘ may be explained while rephrasing the described index “1” of the symbol in each battery pack 10 in the explanation for the battery manager IC11₁ to an index “m” or the like.

### (Current Flow)

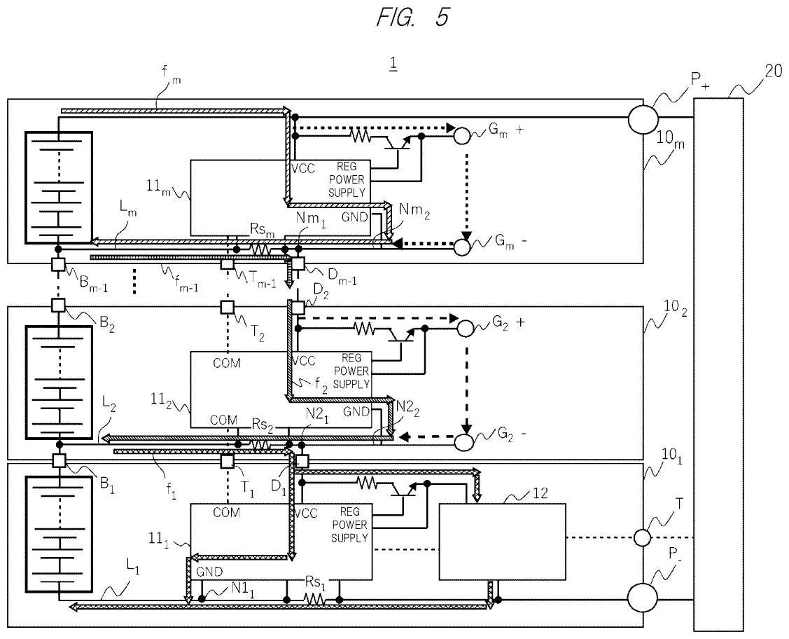

Next, with reference to FIG. 5, a current flow in each battery pack 10 according to the embodiment will be explained. FIG. 5 is a diagram showing an example of the current flow in each battery pack 10 according to the embodiment. FIG. 5 shows an arrow f₁, an arrow f₂, and an arrow fₘ showing current flows consumed in the battery packs 10₁, 10₂ and 10ₘ, respectively.

### (Current Flow of Battery Pack 10₁ (Bottom Module))

In the example of FIG. 5, the current from the positive electrode of the first cell group flows toward the battery pack 10₂ through the connection point B₁, and flows through the line L₂ including the sensing resistor R_{S2}, and returns toward the battery pack 10₁ through the connection point D₁. Then, the current branches into two routes, and the current on one route flows through the controller 12 and the sensing resistor R_{S1} toward the line L₁, and returns toward the negative electrode of the first cell group. And, the current on the other route flows through the battery manager IC11₁ but not the sensing resistor R_{S1} toward the line L₁, and returns toward the negative electrode of the first cell group.

### (Current Flow of Battery Pack 10ₖ (Middle Module))

First, the current flow in the battery pack 10ₖ (middle module) will be explained. A term “k” described here is an integer number that is any of 2 to (m−1). In the example of FIG. 5, the current from the positive electrode of the k-th cell group flows toward the battery pack 10ₖ₊₁ (not illustrated) through the connection point Bₖ, and flows through the line Lₖ₊₁ (not illustrated) including the sensing resistor R_{Sk+1} (not illustrated), and returns toward the battery pack 10ₖ through the connection point Dₖ.

If a load such as an LED (Light Emitting Diode) is connected to the external-apparatus connection point Gₖ+/Gₖ−, the current branches into two routes, and the current on one route flows through this load and the sensing resistor R_{Sk} toward the line Lₖ, and returns toward the negative electrode of the k-th cell group. And, the current on the other route flows through the battery manager IC11ₖ and the sensing resistor R_{Sk} toward the line Lₖ, and returns toward the negative electrode of the k-th cell group.

On the other hand, if the load is not connected to the external-apparatus connection point Gₖ+/Gₖ−, the current flows through the battery manager IC11₂ and the sensing resistor R_{Sk} toward the line Lₖ, and returns toward the negative electrode of the k-th cell group. For example, the current flow in the battery pack 10₂ that is one of the middle modules is illustrated as the current f₂ in FIG. 5.

### (Current Flow of Battery Pack 10ₘ (Top Module))

In the example of FIG. 5, if a load such as an LED is connected to the external-apparatus connection point Gₘ+/Gₘ−, the current flowing from the positive electrode of the m-th cell group branches into two routes, and the current on one route flows through this load and the sensing resistor R_{Sm} toward the line Lₘ, and returns toward the negative electrode of the m-th cell group. And, the current on the other route flows through the battery manager IC11ₘ and the sensing resistor R_{Sm} toward the line Lₘ, and returns toward the negative electrode of the m-th cell group.

On the other hand, if the load is not connected to the external-apparatus connection point Gₘ+/Gₘ−, the current flows through the battery manager IC11ₘ and the sensing resistor R_{Sm} toward the line Lₘ, and returns toward the negative electrode of the m-th cell group. The series of current flow is illustrated as the current fₘ in FIG. 5.

### <Process>

### <<Balance Process Among Battery Packs 10>>

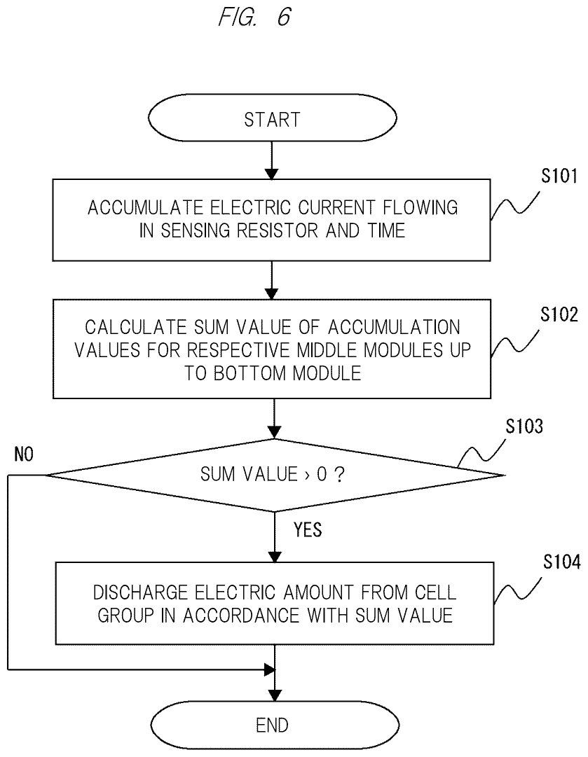

Next, with reference to FIG. 6, an example of a process of balancing the battery packs 10 according to the embodiment will be explained. FIG. 6 is a flowchart showing the example of the process of balancing the battery packs 10 according to the embodiment. Note that the process of FIG. 6 may be executed at, for example, a periodical timing or the like.

In a S101, from the following formula (1), a controlling portion 115ⱼ (“j” is an integer number that is any of 2 to “m”) calculates an accumulation (integral) value “Sⱼ” of the current “Lⱼ” flowing in the sensing resistor R_{Sj} of the battery pack 10ⱼ and time “t” taken for the current flow. In this case, the controlling portion 115ⱼ sets the current flowing in a direction from the positive electrode of the cell group of the battery pack 10ⱼ₋₁ through the connection point Bⱼ₋₁ toward the sensing resistor R_{Sj} (that is a direction from left to right) as a positive current.

$${S}_{j} = \int {I}_{j} dt \qquad ( 1 )$$

Next, the controlling portion 115ⱼ calculates a sum value SAⱼ of the accumulation values each made of the current flowing in the sensing resistor of each of the battery packs 10₂ to 10ⱼ (the battery pack 10ⱼ and other middle modules connected between the battery pack 10ⱼ and the bottom module) and the time taken for the current flow (step S102). In this case, an index “1” is any of 2 to “j”.

$${SA}_{j} = \sum {S}_{1} \qquad ( 2 )$$

In the battery pack 10₂, “SA₂=S₂” is satisfied because of the formula (2), and therefore, the process of the step S102 is unnecessary. In the battery pack 10₃, “SA₃=S₂+S₃” is satisfied because of the formula (2). Note that the controlling portion 115ⱼ of the battery pack 10₃ to the battery pack 10ₘ may acquire a sum value SAⱼ₋₁ of the accumulation values each made of the current flowing in the sensing resistor of each of the battery packs 10₂ to 10ⱼ₋₁ and the time taken for the current flow, by using communication from the battery pack 10ⱼ₋₁ or the controller 12 through a terminal COM.

Next, the controlling portion 115ⱼ determines whether the sum value SAⱼ is larger than 0 (step S103). If the sum value SAⱼ is not larger than 0 (the determination indicates “NO” in the step S103), the process ends.

On the other hand, if the sum value SAⱼ is larger than 0 (the determination indicates “YES” in the step S103), the discharge of the electrical amount (=“Current×Time”) depending on the sum value SAⱼ starts from the cell group of the battery pack 10ⱼ by using the cell balance 111ⱼ (step S104), and the process ends. In this manner, the battery capacities of the respective battery packs 10 are the same as one another.

Alternatively, the battery capacity of the battery pack 10 may be reduced by not the discharge in the step S104 but consumption of the current in the battery pack 10 by using an external device. For example, a load such as LED may be connected between the external-apparatus connection point Gₘ+ and the external-apparatus connection point Gₘ−, and the current may be consumed by the load.

In the apparatus explained in FIG. 1, the controller 12 is connected to the battery pack 10₁ that is the bottom module. Therefore, the current consumption amount of the battery pack 10₁ is larger by the current consumption amount of the controller 12 than the current consumption amount of other battery packs 10. Therefore, if the plurality of battery packs 10 each including the plurality of battery cells that are connected in series are connected in series, the remaining capacity of the plurality of battery cells of each battery pack 10 is varied (unbalanced) by a difference in the current consumption amount among the battery packs 10.

According to the present disclosure, each of the top module and the 0-th middle module or the middle module with a larger-ordinal-number-th has a mechanism that measures the difference in the current consumption amount between itself and a module at a stage that is lower by one. Then, in each module, the electric amount depending on the sum value of the differences is discharged. Therefore, in the case in which the plurality of battery packs 10 each including the plurality of battery cells that are connected in series are connected in series for use, the cell balance of each module can be more suitably executed.

(Controlling Portion 115₁ to Controlling portion 115ₘ)

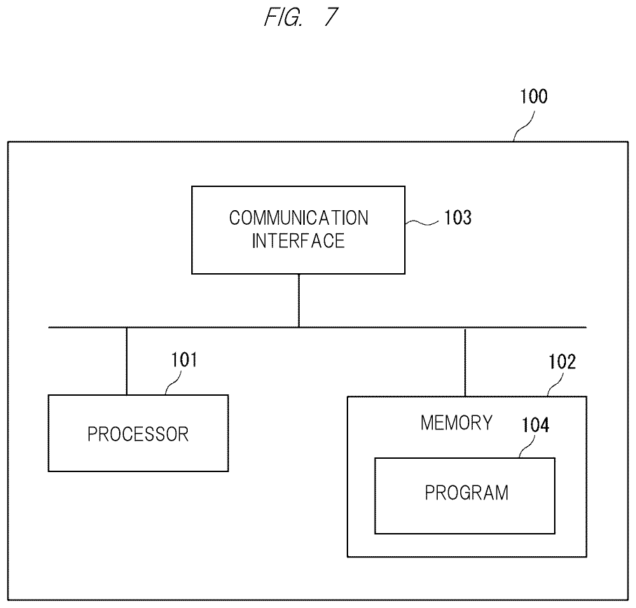

FIG. 7 is a diagram showing an example of a configuration of the controlling portion 115₁ to the controlling portion 115ₘ (also simply referred to as “controlling portion 115” below unless otherwise they are needed to be discriminated) according to the embodiment. In the example of FIG. 7, the controlling portion 115 includes a processor 10₁, a memory 10₂, and a communication interface 10₃. Each of these components may be connected by a bus or the like. The memory 10₂ stores at least a part of a program 104. The communication interface 10₃ includes an interface necessary for communication with other network element.

When the program 104 is executed in corporation with the processor 10₁ and the memory 10₂ or the like, at least a part of the processes of the embodiment of the present disclosure is performed by a computer 100. A type of the memory 10₂ may be any type. The memory 10₂ may be a non-transitory computer readable storage medium as a non-restrictive example. And, the memory 10₂ may be mounted by an any suitable data storage technique such as a semiconductor-based memory device, a magnetic memory device and system, an optical memory device and system, and a stationary memory and a removable memory. Only one memory 10₂ is illustrated in the computer 100. However, the computer 100 may include some physically-different memory modules. A type of the processor 10₁ may be any type. The processor 10₁ may include one or more of a general-use computer, a dedicated-use computer, a microprocessor, a Digital Signa Processor (DSP), and a processor based on a multi-core processor architecture as a non-restrictive example. The computer 100 may include a plurality of processors such as a particular-use integrated circuit chip temporally depending on a clock for synchronization of a main processor.

The program can be stored by using various types of a non-transitory computer readable medium, and can be provided to the computer. The non-transitory computer readable medium includes various types of a tangible storage medium. Examples of the non-transitory computer readable medium include a magnetic recording medium, a magnetooptical recording medium, an optical disc medium, a semiconductor memory and the like. Examples of the magnetooptical recording medium include a magnetooptical disc and the like. Examples of the optical disc medium include a Blu-ray disc, CD (Compact Disc)-ROM (Read Only Memory), CD-R (Recordable), CD-RW (Writable) and the like. Examples of the semiconductor memory include a solid state drive, a mask ROM, a PROM (Programmable ROM), EPROM (Erasable PROM), a flash ROM, a RAM (Random Access Memory) and the like. Also, the program may be provided to the computer by various types of a transitory computer readable medium. Examples of the transitory computer readable medium include an electrical signal, an optical signal and an electromagnetic wave. The transitory computer readable medium can provide the program to the computer through a wired communication path such as an electrical wire and an optical fiber or a wireless communication path.

### Modification Example

In the above-described examples, the explanation is about the example in which the sum value SAⱼ used for the process of balancing the battery packs 10 is calculated by the controlling portion 115 of each battery pack 10. However, the present disclosure is not limited to these examples. The sum value SAⱼ may be calculated by, for example, the controller 12.

Note that the battery pack 10₁ is one example of the “first battery module”. The battery pack 10₂ is one example of the “second battery module”. If the “m” is 3, the battery pack 10ₘ is one example of the “third battery module”. The line L₁ is one example of the “first line”. The line L₂ is one example of the “second line”. If the “m” is 3, the line Lₘ is one example of the “third line”. The connection point N2₁ is one example of the “first connection point”. The sensing resistor Rs₂ is one example of the “first sensing resistor”. The connection point Nm₁ is one example of the “second connection point”. The sensing resistor Rsₘ is one example of the “second sensing resistor”.

What is claimed is:

1. A semiconductor device comprising:
a first battery module and a second battery module connected in series,
the first battery module comprising:
a first controlling portion controlling a first cell group where a plurality of battery cells are connected in series; and
a controller communicating with a device driven when receiving a power supply from the first and second battery modules,
the second battery module comprising:
a second controlling portion controlling a second cell group where a plurality of battery cells are connected in series; and
a first measuring circuit measuring a difference in a consumed electrical amount between the first battery module and the second battery module,
wherein discharge starts from the plurality of battery cells in the second cell group, based on the difference in the consumed electrical amount measured by the first measuring circuit.

2. The semiconductor device according to claim 1,
wherein a positive electrode of the first cell group and a negative electrode of the second cell group are electrically connected to each other,
the first battery module comprises a first line connected to a negative electrode of the first cell group,
the second battery module comprises a second line connected to the positive electrode of the first cell group and the negative electrode of the second cell group,
the first controlling portion and the controller receive a power supply from the second line connected at a first connection point, and are grounded at the first line,
the second controlling portion receives a power supply from a positive electrode of the second cell group, and is grounded at the second line,
the first connection point is provided on the second line, and
the first measuring circuit measures a current flowing in a first sensing resistor provided between the positive electrode of the first cell group and the first connection point.

3. The semiconductor device according to claim 1, further comprising
a third battery module connected in series to the first battery module and the second battery module,
the third battery module comprising:
a third controlling portion controlling a third cell group where a plurality of battery cells are connected in series; and
a second measuring circuit measuring a difference in a consumed electrical amount between the second battery module and the third battery module,
wherein discharge starts from the plurality of battery cells included in the third cell group, based on a sum value of a difference in a consumed electrical amount measured by the second measuring circuit and the difference in the consumed electrical amount measured by the first measuring circuit.

4. The semiconductor device according to claim 3,
wherein a positive electrode of the first cell group and a negative electrode of the second cell group are electrically connected to each other,
the first battery module comprises a first line connected to a negative electrode of the first cell group,
the second battery module comprises a second line connected to the positive electrode of the first cell group and the negative electrode of the second cell group,
the first controlling portion and the controller receive a power supply from the second line connected at a first connection point, and are grounded at the first line,
the second controlling portion receives a power supply from a positive electrode of the second cell group, and is grounded at the second line,
the first connection point is provided on the second line,
the first measuring circuit measures a current flowing in a first sensing resistor provided between the positive electrode of the first cell group and the first connection point,
the positive electrode of the second cell group and a negative electrode of the third cell group are electrically connected to each other,
the third battery module comprises a third line connected to the positive electrode of the second cell group and the negative electrode of the third cell group,
the second controlling portion receives a power supply from the third line connected at a second connection point,
the third controlling portion receives a power supply from a positive electrode of the third cell group, and is grounded at the third line,
the second connection point is provided on the third line, and
the second measuring circuit measures a current flowing in a second sensing resistor provided between the positive electrode of the second cell group and the second connection point.

5. A method of balancing a battery module, comprising:
providing a battery module comprising a first battery module and a second battery module,
the first battery module comprising
a first cell group where a plurality of battery cells are connected in series; and
a controller communicating with a device driven when receiving a power supply from the first and second battery modules,
the second battery module comprising a second cell group where a plurality of battery cells are connected in series,
measuring a difference in a consumed electrical amount between the first battery module and the second battery module; and
starting discharge from the plurality of battery cells included in the second cell group, based on the measured difference in the consumed electrical amount.

6. The method of balancing the battery module according to claim 5,
providing a third battery module in the battery modules connected in series to the first battery module and the second battery module, the third battery module comprising a third cell group where a plurality of battery cells are connected in series,
measuring a difference in a consumed electrical amount between the second battery module and the third battery module; and
starting discharge from the plurality of battery cells included in the third cell group, based on a sum value of the difference in the consumed electrical amount between the first battery module and the second battery module and the difference in the consumed electrical amount between the second battery module and the third battery module.

7. A battery module system comprising:
a first battery module and a second battery module connected in series,
the first battery module comprising
a first cell group where a plurality of battery cells are connected in series;
a first controlling portion controlling the first cell group; and
a controller communicating with a main body of an apparatus,
the second battery module comprising
a second cell group where a plurality of battery cells are connected in series;
a second controlling portion controlling the second cell group; and
a first measuring circuit measuring a difference in a consumed electrical amount between the first battery module and the second battery module,
wherein discharge starts from the plurality of battery cells included in the second cell group, based on the difference in the consumed electrical amount measured by the first measuring circuit.

8. The battery module system according to claim 7, further comprising
a third battery module connected in series to the first battery module and the second battery module,
the third battery module comprising:
a third controlling portion controlling a third cell group where a plurality of battery cells are connected in series; and
a second measuring circuit measuring a difference in a consumed electrical amount between the second battery module and the third battery module,
wherein discharge starts from the plurality of battery cells included in the third cell group, based on a sum value of the difference in the consumed electrical amount measured by the second measuring circuit and the difference in the consumed electrical amount measured by the first measuring circuit.
